(19) United States
(12) Patent Application Publication
(10) Pub. No.: US 2025/0381821 A1
(43) Pub. Date: Dec. 18, 2025

(54) Vehicle Interior Ventilation Device with a Pressure Relief Valve Arrangement

(71) Applicant: Illinois Tool Works Inc., Glenview, IL (US)

(72) Inventors: Stefan Jatzke, Bockenheim an der Weinstraße (DE); Andreas Senn, Neuhemsbach (DE)

(21) Appl. No.: 19/224,092

(22) Filed: May 30, 2025

(30) Foreign Application Priority Data
Jun. 17, 2024 (DE) 10 2024 116 916.8

(51) Int. Cl. B60H 1/24; B60H 1/00

(52) U.S. Cl. CPC B60H 1/249; B60H 1/008; B60H 1/00671

(57) ABSTRACT

The disclosure relates to a vehicle cabin ventilation apparatus (20) having a pressure limitation valve assembly (21) and a frame-like component (22) for laterally enclosing and/or fixing the pressure limitation valve assembly (21) in a receptacle opening of a vehicle body component (30). The vehicle cabin ventilation apparatus (20) comprises a ventilator device (23) that is or can be actuated as needed.

### RELATED APPLICATIONS

The present application claims the benefit of German Patent Application No. 102024116916.8, filed June 17, 2024, titled “Vehicle Interior Ventilation Device with a Pressure Relief Valve Arrangement,” the contents of which are hereby incorporated by reference.

### BACKGROUND

Air ventilation apparatuses or pressure limitation valve assemblies for the interior of vehicles typically have a frame surrounding a vent opening on which at least one valve lies externally, said valve covering the vent opening and being pivotable away from it.

Such air ventilation apparatuses and pressure limitation valve assemblies are generally known in various embodiments. In this context, for example, reference is made to the publication DE 3503600 A1. In the pressure limitation valve assembly known from this prior art, an airflow from the interior of the vehicle can pass outwardly via the vent opening, namely in that this airflow lifts the at least one flap of the pressure limitation valve assembly away from the frame due to the adjustment of pressure ratios. On the other hand, the ingress of ambient air into the interior of the vehicle through the flap, which is now resting on the frame, is successfully prevented.

Accordingly, pressure limitation valve assemblies of the type considered herein serve to reduce the build-up of air pressure in the interior of the vehicle, for example when closing a tailgate of the vehicle. The pressure limitation valve, typically configured as a flap, can open at an increased air pressure in the interior of the vehicle in order to allow air to escape within the interior, thereby reducing air pressure in the interior of the vehicle and reducing the effort needed in order to, for example, close the tailgate. Moreover, a vehicle having a pressure limitation valve assembly can influence airflow from the vehicle cabin in order to increase passenger comfort. Because a climate system draws ambient air from outside the vehicle and introduces air into the vehicle cabin, a venting through the pressure limitation valve assembly is required in order to achieve proper circulation and reduce the pressure build-up.

Particularly when opening the pressure limitation valve associated with the pressure limitation valve assembly, however, noise from outside can permeate through the opening. In addition, even in the closed state of the pressure limitation valve, outside noise can enter the vehicle cabin. Moreover, in certain driving situations, the closing noise of the pressure limitation valve can be perceived as disruptive to the vehicle occupants.

In order to reduce the ingress of noise and exterior elements into the vehicle cabin, pressure limitation valves can be designed to be as small as possible, however, this limits the rate at which pressure compensation can be achieved with the pressure limitation valve assembly.

Alternatively, in the case of pressure compensation caused by means of the pressure limitation valve assembly, it is contemplated to provide the pressure limitation valve assembly with a type of “muffler” in order to reduce noise. For this purpose, it is known to place a cover on the pressure limitation valve assembly in order to form a muffler space, wherein, when the pressure limitation valve assembly is open, a flow-like path between the vehicle cabin and the outer atmosphere passes through the muffler space at least regionally.

### SUMMARY

The present disclosure relates generally to a ventilation apparatus, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates schematically and in a first isometric view, an exemplary embodiment of a ventilation apparatus.

FIG. 2 illustrates schematically and in a second isometric view, the first exemplary embodiment of the ventilation apparatus.

FIG. 3 illustrates schematically and in a first isometric exploded view, the first exemplary embodiment of the ventilation apparatus.

FIG. 4 illustrates schematically and in a second isometric exploded view, the first exemplary embodiment of the ventilation apparatus.

FIG. 5 illustrates schematically and in a cross-sectional view, the first exemplary embodiment of the ventilation apparatus in a state in which the pressure limitation valve assemblies are in their respective closed position.

FIG. 6 illustrates schematically and in a cross-sectional view, the first exemplary embodiment of the ventilation apparatus in a state in which the pressure limitation valve assemblies are shown in their respective open position.

FIG. 7 illustrates schematically and in an isometric cross-sectional view, the first exemplary embodiment of the ventilation apparatus.

FIG. 8 illustrates schematically and in a first isometric view, a second exemplary embodiment of the ventilation apparatus according to the disclosure.

FIG. 9 illustrates schematically and in a second isometric view, the second exemplary embodiment of the ventilation apparatus according to the disclosure.

FIG. 10 illustrates schematically and in a first isometric exploded view, the second exemplary embodiment of the ventilation apparatus according to the disclosure.

FIG. 11 illustrates schematically and in a second isometric exploded view, the second exemplary embodiment of the ventilation apparatus according to the disclosure.

FIG. 12 illustrates schematically and in a cross-sectional view, the second exemplary embodiment of the ventilation apparatus according to the disclosure.

FIG. 13 illustrates schematically and in an isometric exploded view, a third exemplary embodiment of the ventilation apparatus according to the disclosure.

FIG. 14 illustrates schematically and in a second isometric exploded view, the third exemplary embodiment of the ventilation apparatus according to the disclosure.

FIG. 14 illustrates schematically and in a second isometric exploded view, the third exemplary embodiment of the ventilation apparatus according to the disclosure.

FIG. 15 illustrates schematically and in an isometric view, the third exemplary embodiment of the ventilation apparatus according to the disclosure.

FIG. 16 illustrates schematically and in a cross-sectional view, the third exemplary embodiment of the ventilation apparatus according to the disclosure.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein is not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent to or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure relates generally to air ventilation apparatuses for the interior of vehicles, wherein such air ventilation apparatuses are also referred to herein as “pressure limitation valve assemblies.”

The problem addressed by the present disclosure is to further develop a ventilation apparatus for a vehicle cabin of the aforementioned kind, such that the passive safety of the vehicle as a whole is increased.

In particular, there is a need for appropriate ventilation apparatuses to ensure that pollutants cannot enter the vehicle cabin from the outside. This applies on the one hand in the case of “normal” driving operation of the vehicle, but also when, for example, due to a defect, for example of a battery of the vehicle, the battery begins to burn and thereby releases pollutants.

Accordingly, the disclosure relates in particular to a vehicle cabin ventilation apparatus having a pressure limitation valve assembly and a frame-like component for laterally enclosing and/or fixing the pressure limitation valve assembly in a receptacle opening of a vehicle body component.

The ventilation apparatus according to the disclosure is characterized in particular in that the vehicle cabin ventilation apparatus comprises a ventilator device that is or can be actuated as needed.

In other words, the disclosure relates to a ventilation apparatus with which vehicle safety is increased by an active device, namely by the ventilator device, which can be actuated as needed.

According to implementations of the ventilation apparatus according to the disclosure, it is provided that the ventilation apparatus comprises a cover that at least partially or regionally forms a housing and preferably is or can be connected to the frame-like component of the pressure limitation valve assembly via a positive-locking connection, in particular a clip connection, preferably in a releasable or exchangeable manner. In a state when connected to the frame-like component of the pressure limitation valve assembly, the cover at least partially or regionally receives the ventilator device and positions or fixes it accordingly.

In particular, in a state of the cover when it is connected to the frame-like component of the pressure limitation valve assembly, the ventilator device can be received at least partially or regionally in a region delimited by the cover and the frame-like component.

Alternatively, it is contemplated that the cover is configured so as to at least partially or regionally receive the ventilator device, preferably in a detachable or exchangeable manner.

In this context, it is contemplated that the cover comprises in particular a receiving region, which is designed so as to be complementary at least partially or regionally in particular to an outer contour of the ventilator device, in which region the ventilator device is receivable.

According to further developments of the last mentioned design variant, it is provided that the cover comprises a first end-side inlet region and an opposing second end-side outlet region, wherein the pressure limitation valve assembly is or can be arranged at or in the outlet region of the cover.

The ventilator device is or can be arranged at or in the inlet region of the cover.

In the ventilation apparatus according to the disclosure, the pressure limitation valve assembly preferably comprises at least one check valve, which is configured so as to permit a gas flow, and in particular an air flow, only from the inlet region to or through the outlet region of the cover.

It is expedient here that the at least one check valve comprises at least one closing element, in particular in the form of a check flap, wherein the at least one closing element can be moved, and in particular pivoted, between an open position and a closed position.

For example, the at least one check valve is configured such that the at least one closing element is pressed into a sealing seat associated with the at least one closing element by way of gravity and/or by way of the flow pressure of the gas flow and in particular air flow.

Alternatively, however, it is also contemplated that the at least one check valve is configured as a spring-loaded check valve.

The ventilator device used in the ventilation apparatus according to the disclosure is preferably configured so as to initiate a gas flow, and in particular an air flow, from the inlet region to or through the outlet region of the cover, as needed.

According to implementations of the ventilation apparatus according to the disclosure, it is in particular expedient for the ventilator device to comprise at least one axial fan.

Preferably, the ventilator device is associated with an energy source, being in particular independent from the power supply of the vehicle, for the as-needed power supply of the ventilator device.

According to implementations of the ventilation apparatus according to the disclosure, it is provided that the ventilation apparatus comprises at least one sensory system. Alternatively, however, at least one sensory system can also be associated with the ventilation apparatus.

The at least one sensory system comprises at least one air quality sensor, which is configured so as to monitor the air, in particular in the vehicle cabin and/or in the housing formed at least partially or regionally by the cover, continuously or at predefined or definable times and/or events, with the task of detecting and measuring pollutants.

In a further development of the last mentioned design variant, the ventilation apparatus comprises a control device, and the ventilation apparatus is associated with a control device, which is configured so as to evaluate a type and/or concentration of any pollutants measured by the at least one air quality sensor and to actuate the ventilator device upon reaching and/or exceeding a critical pollutant type and/or pollutant concentration.

Alternatively or in addition to a ventilator device that can be actuated as needed, vehicle safety can also be increased by a passive device.

For example, it is contemplated that the vehicle cabin ventilation apparatus is equipped with a first pressure limitation valve assembly and a frame-like component for laterally bordering and/or fixing the pressure limitation valve assembly in a receiving opening of a vehicle body component, and a second pressure limitation valve assembly, which is arranged in serial, fluidic connection with the first pressure limitation valve assembly in such a way that a flow-calming zone is formed between the first and second pressure limitation valve assemblies.

The advantages that can be achieved with this design variant, which can also be used in combination with the ventilator device, are obvious: due to the fact that two pressure limitation valve assemblies are fluidically connected in series, wherein a calming zone is formed between the two pressure limitation valve assemblies, it can be effectively prevented that air, possibly containing pollutants, enters the vehicle cabin from the exterior of the vehicle.

In this respect, the disclosure is based on the finding that in conventional ventilation apparatuses that only comprise one pressure limitation valve assembly, there is a risk that the pressure limitation valve assembly will open at least partially or regionally when a turbulent flow field is present at the outlet region of the pressure limitation valve assembly. This situation can occur in particular when there is no positive pressure in the vehicle cabin (compared to the pressure of the outer atmosphere) and a turbulent flow field is present in the outlet region of the pressure limitation valve assembly. In such a situation, if the pressure limitation valve assembly opens due to the swirl field, the classic ventilation apparatuses will not prevent the ingress of pollutants into the vehicle cabin.

Due to the fact that a further (second) pressure limitation valve assembly is fluidically positioned downstream of the first (outer) pressure limitation valve assembly, it can be effectively prevented that outside air and/or pollutants enter the vehicle cabin. Even if, due to an outer swirl field, the first (outer) pressure limitation valve assembly at least partially or regionally opens, the second (inner) pressure limitation valve assembly remains in its closed position, because the provision of the calming zone between the first and second pressure limitation valve assemblies prevents an unwanted opening of the second (inner) pressure limitation valve assembly that can be attributed to a flowing swirl field.

The solution according to the disclosure in particular allows for pressure limitation valve assemblies to be used that have only a very low flow resistance.

In other words, the pressure limitation valve assemblies used in the solution according to the disclosure only lead to a low pressure drop, while ensuring that an unwanted penetration of pollutants into the vehicle cabin is avoided.

According to implementations of the ventilation apparatus according to the disclosure, it is provided that it comprises a housing, which at least partially or regionally defines a flow passage. The housing comprises a first end-side inlet region and an opposing second end-side outlet region. The first (outer) pressure limitation valve assembly is arranged at or in the outlet region of the housing, while the second (inner) pressure limitation valve assembly is or can be arranged at or in the inlet region of the housing.

In this context, it is generally contemplated that the frame-like component of the first pressure limitation valve assembly is an integral part of the housing. In other words, the frame-like component of the first pressure limitation valve assembly can be integral with the housing. Alternatively, however, it is also contemplated that the frame-like component of the first pressure limitation valve assembly is connected to the housing in a material-locking manner, for example by adhesion or welding.

Alternatively, however, it is of course also contemplated that the frame-like component of the first pressure limitation valve assembly is or can be connected to the outlet region of the housing in particular via a positive connection, for example via a clip connection.

In principle, it is contemplated that the second pressure limitation valve assembly (likewise) comprises a frame-like component for laterally bordering and/or fixing the second pressure limitation valve assembly. Again, it is generally contemplated that the frame-like component of the second pressure limitation valve assembly is an integral part of the housing.

However, it is preferred that the frame-like component of the second pressure limitation valve assembly is or can be connected to the inlet region of the housing in particular via a positive connection, preferably a clip connection.

The housing of the ventilation apparatus at least partially or regionally bounds the flow-calming zone between the first and second pressure limitation valve assemblies.

According to implementations of the ventilation apparatus according to the disclosure, it is provided that the pressure limitation valve assembly comprises at least one check valve, which is configured so as to permit a gas flow, and in particular an air flow, only from the inlet region to or through the outlet region of the housing.

It is likewise advantageous that the second pressure limitation valve assembly comprises at least one check valve, which is configured so as to permit a gas flow, and in particular an air flow, only from or through the inlet region to the outlet region of the housing.

The at least one check valve preferably comprises at least one closing element, in particular in the form of a check flap. The at least one closing element of the at least one check valve can be moved, and in particular pivoted, between an open position and a closed position.

It is particularly expedient here that the at least one check valve is configured such that the at least one closing element is pressed into a sealing seat associated with the at least one closing element by way of gravity and/or by way of the flow pressure of the gas flow and in particular air flow.

Alternatively, however, it is also contemplated that the at least one check valve is configured as a spring-loaded check valve.

The flow-calming zone has dimensions and/or is designed so as to ensure that turbulent flows can no longer occur in the calming zone that could inadvertently open the second pressure limitation valve assembly.

With regard to a simplified construction of the ventilation apparatus according to the disclosure, it is provided according to embodiments of the disclosure that the second pressure limitation valve assembly is at least substantially identical to the first pressure limitation valve assembly.

The first exemplary embodiment of the ventilation apparatus 1 comprises a first pressure limitation valve assembly 2 and a second pressure limitation valve assembly 4 arranged in serial, fluidic connection with the first pressure limitation valve assembly 2. A calming zone 6 is formed between the two serially fluidically connected pressure limitation valve assemblies 2, 4.

Each pressure limitation valve assembly 2, 4 comprises a frame-like component 3, 5, with which the pressure limitation valve assembly 2, 4 is laterally bordered.

The pressure limitation valve assembly 2, 4 itself comprises at least one check valve, which is configured so as to permit a gas flow, and in particular an air flow, only from an inlet region 8 of the ventilation apparatus 1 to or through an outlet region 9 of the ventilation apparatus 1.

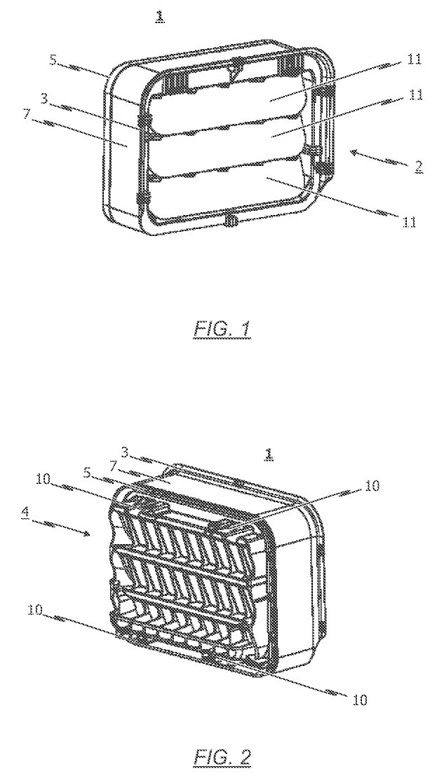

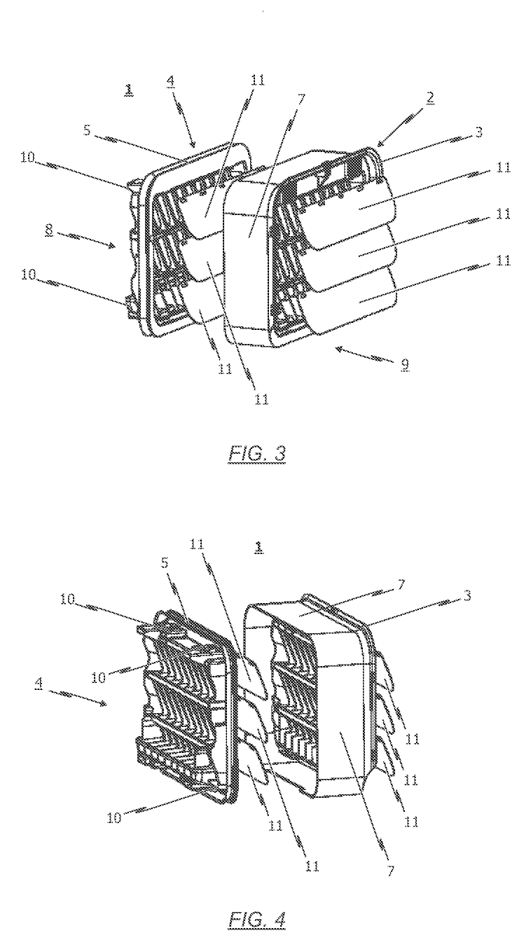

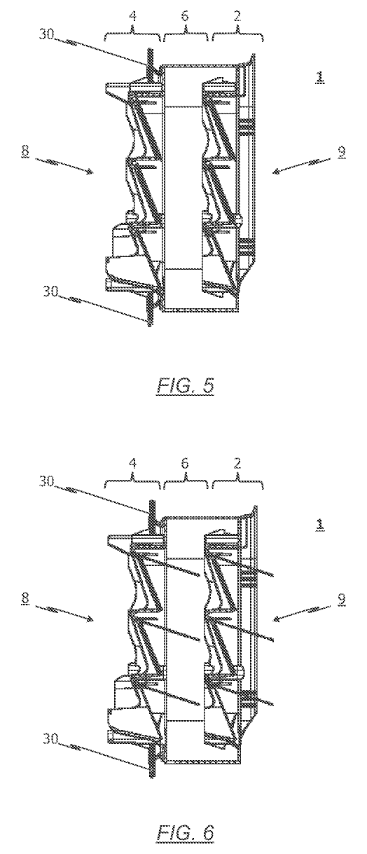

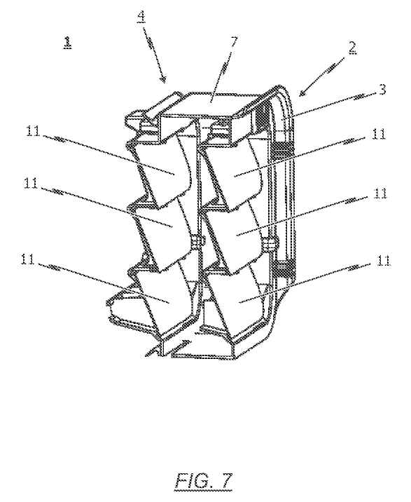

As shown in FIG. 1 through FIG. 7, the exemplary embodiment of the ventilation apparatus 1 further comprises a housing 7 defining a flow passage. The housing 7 comprises a first end-side inlet region 8 and an opposing second end-side outlet region 9. The first pressure limitation valve assembly 2 is arranged at or in the outlet region 9 of the housing, and the second pressure limitation valve assembly 4 is arranged at or in the inlet region 8 of the housing 7.

In the design variant of the ventilation apparatus 1 shown in FIG. 1 to FIG. 7, the frame-like component 3 of the first pressure limitation valve assembly 2 is fixedly connected to the end-side outlet region 9 of the housing 7. In particular, it is contemplated that the frame-like component 3 of the first pressure limitation valve assembly 2 is integrally connected to the housing 7 or to the end-side outlet region 9 of the housing 7.

However, it is of course also contemplated that the frame-like component 3 of the first pressure limitation valve assembly 2 can be connected to the outlet region 9 of the housing 7 in a detachable manner, for example via a positive connection, such as a clip connection 10.

The frame-like component 5 of the second pressure limitation valve assembly 4 is connected to the inlet region 8 of the housing 7, wherein a positive connection, in particular the clip connection 10, is preferably used for this purpose.

As can be seen from the sectional views according to FIG. 5 and FIG. 6, the frame-like component 5 of the second pressure limitation valve assembly 4 serves to fix the ventilation apparatus 1 in a receiving opening of a vehicle body component 30.

Of course, however, it is also contemplated that the ventilation apparatus 1 is connected to the vehicle body component 30 via the frame-like component 3 of the first pressure limitation valve assembly 2.

The first and second pressure limitation valve assemblies 2, 4 are preferably at least substantially identical in design.

As shown in the drawings, each pressure limitation valve assembly 2, 4 comprises a plurality of check valves (here, three check valves, respectively). Each check valve comprises one closing element 11 in the form of a check flap, wherein the closing element 11 can be moved, and in particular pivoted, between an open position (cf. FIG. 6) and a closed position (FIG. 5).

In the ventilation apparatus 1 shown schematically in FIG. 1 to FIG. 7, it is provided that the closing elements 11 of the respective check valves are pushed into a seal seat associated with the respective closing element 11 by way of gravity and by the flow pressure of a gas, and in particular air, flow.

Between the two serially fluidically connected pressure limitation valve assemblies 2, 4, the aforementioned calming zone 6 is provided. This serves to calm any turbulent air flows that penetrate the first (outer) pressure limitation valve assembly 2, in particular.

When viewed in the direction of flow through the ventilation apparatus 1, a length of the calming zone 6 is 0.5 times to 1.5 times, and preferably 0.8 times to 1.2 times, a length of a closing element 11 of the check valve of the second pressure limitation valve assembly 4.

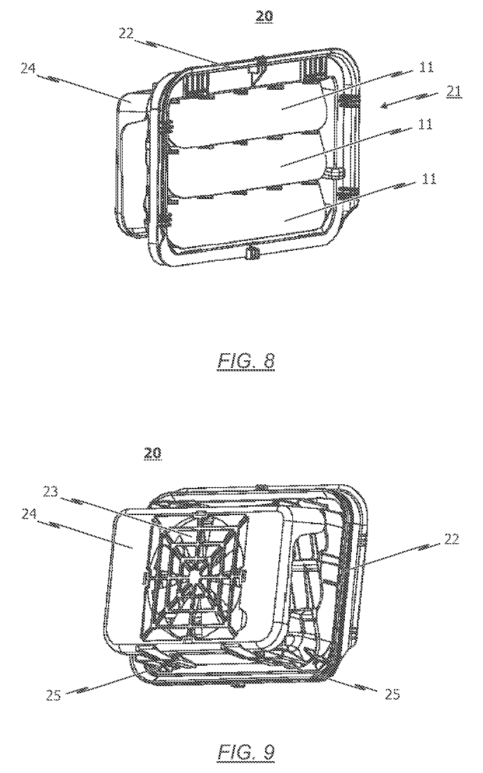

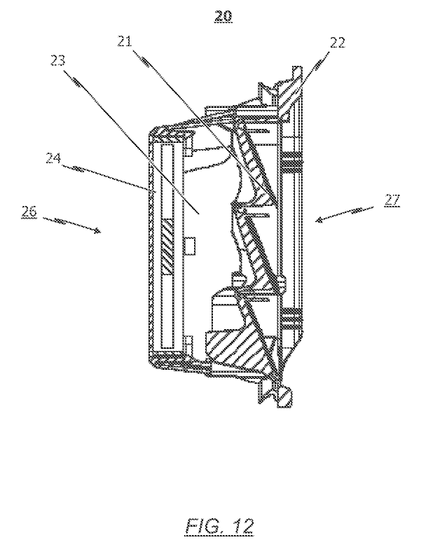

Referring to the illustrations in FIG. 8 to FIG. 12, an exemplary embodiment of the ventilation apparatus 20 according to the disclosure will be described in further detail below.

The exemplary embodiment of the ventilation apparatus 20 according to the disclosure shown schematically in FIG. 8 to FIG. 12 only comprises a pressure limitation valve assembly 21, which is associated with a frame-like component 22 for laterally bordering and/or fixing the pressure limitation valve assembly 21. The ventilation apparatus 20 can also be connected to a vehicle body component via the frame-like component 22.

The exemplary embodiment of the ventilation apparatus 20 according to the disclosure is wherein it comprises a ventilator device 23, which is or can be actuated as needed.

The ventilator device 23 can comprise an axial fan, as shown in the drawings. However, it is also generally contemplated to use other designs for the ventilator device 23, for example a diagonal fan, a radial/centrifugal fan, or a tangential or cross-flow fan.

Although not shown in the drawings, the ventilator device 23 is associated with an energy source (for example a battery) which is in particular independent from the power supply of the vehicle for the as-needed power supply of the ventilator device 23.

The ventilation apparatus 20 according to the exemplary embodiment of the disclosure further comprises a cover 24 that at least partially or regionally forms a housing.

The cover 24 is preferably connected to the frame-like component 22 of the pressure limitation valve assembly 21 via a positive connection, in particular a clip connection 25, in particular in a releasable or exchangeable connection. In a state when connected to the frame-like component 22 of the pressure limitation valve assembly 21, the cover 24 at least partially or regionally receives the ventilator device 23 and positions the ventilator device 23 accordingly.

The cover 24 comprises a first end-side inlet region 26 and an opposing second end-side outlet region 27, wherein the pressure limitation valve assembly 21 is arranged at or in the outlet region 27 of the cover 24.

The pressure limitation valve assembly 21 comprises at least one check valve (here, a total of three), which is configured so as to permit a gas flow, and in particular an air flow, only from the inlet region 26 to or through the outlet region 27 of the cover 24.

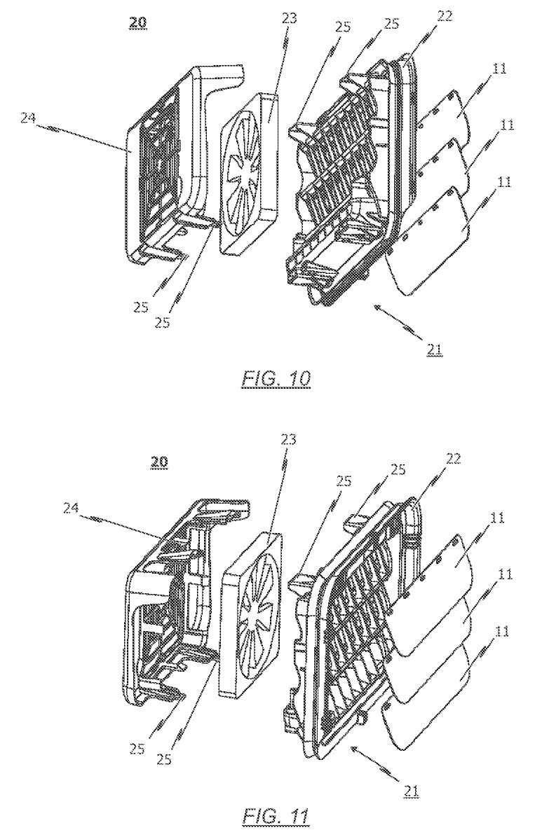

As can be seen for example from the exploded views according to FIG. 10 and FIG. 11, each check valve comprises a closing element 11 in the form of a check flap, wherein the closing element 11 is movable, in particular pivotable, between an open position and a closed position.

The check valve is configured such that the closing element 11 is pressed into a sealing seat associated with the closing element 11 by way of gravity and/or by way of the flow pressure of the gas flow and in particular air flow. However, it is also generally contemplated that the check valve is configured as a spring-loaded check valve.

The ventilator device 23 is configured so as to initiate a gas flow, and in particular an air flow, from the inlet region 26 to or through the outlet region 27 of the cover 24, as needed.

The ventilation apparatus 20 can comprise a sensory system comprising at least one air quality sensor. The air quality sensor is configured so as to monitor the air, in particular in the vehicle cabin and/or in the housing formed at least partially or regionally by the cover 24, continuously or at predefined or definable times and/or events, namely with the task of detecting and measuring pollutants.

It is expedient here that the ventilation apparatus 20 further comprises a control device, which is configured so as to evaluate a type and/or concentration of any pollutants measured by the air quality sensor and to actuate the ventilator device 23 upon reaching and/or exceeding a critical pollutant type and/or pollutant concentration.

In the exemplary embodiment of the ventilation apparatus 20 according to the disclosure as shown schematically in FIGS. 8 to FIG. 12, the ventilator device 23 is received at least partially or regionally in a region bounded by the cover 24 and the frame-like element 22 when the cover 24 is connected to the frame-like element 22 of the pressure limitation valve assembly 21.

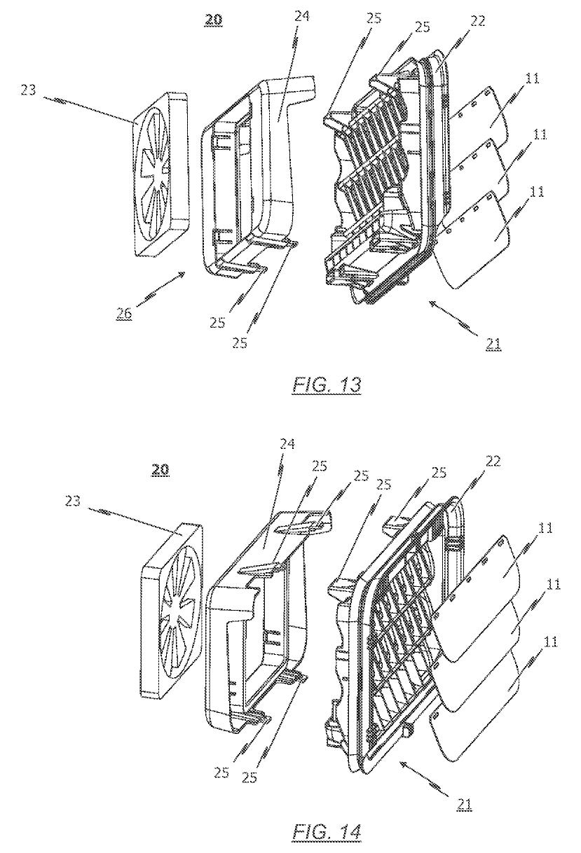

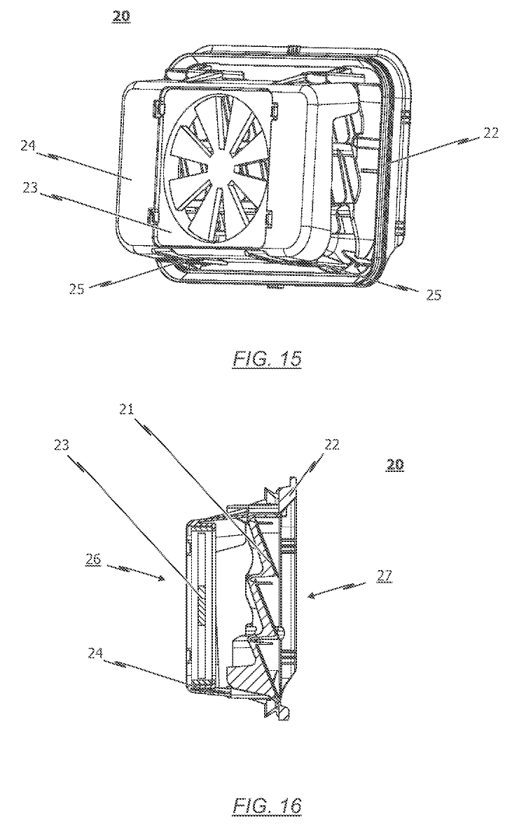

In the (third) exemplary embodiment of the ventilation apparatus 20 according to the disclosure shown in FIG. 13 to FIG. 16, by contrast, the cover 24 is configured so as to at least partially or regionally receive the ventilator device 23 in a preferably detachable or exchangeable manner. For this purpose, the cover 24 comprises a receiving region, which is designed so as to be complementary at least partially or regionally in particular to an outer contour of the ventilator device 23, in which region the ventilator device 23 is receivable.

In a state when the cover 24 is connected to the frame-like component 22 of the pressure valve assembly 21, the ventilator device 23 is arranged at or in the inlet region 26 of the cover 24.

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

List of reference numerals

1 Ventilation apparatus (first embodiment)

2 First pressure limitation valve assembly

3 Frame-like component of the first pressure limitation valve assembly

4 Second pressure limitation valve assembly

5 Frame-like component of the second pressure limitation valve assembly

6 Calming zone

7 Housing

8 Inlet region of the housing

9 Outlet region of the housing

10 Clip connection

11 Check valve/closing element

20 Ventilation apparatus (second and third embodiment)

21 Pressure limitation valve assembly

22 Frame-shaped component of the pressure limitation valve assembly

23 Ventilator device

24 Cover/housing

25 Clip connection

26 Inlet region of the cover

27 Outlet region of the cover

30 Vehicle body component

What is claimed is:

1. A vehicle cabin ventilation apparatus (20) comprising:a pressure limitation valve assembly (21); anda frame-like component (22) for laterally enclosing and/or fixing the pressure limitation valve assembly (21) in a receptacle opening of a vehicle body component (30), wherein the vehicle cabin ventilation apparatus (20) comprises a ventilator device (23) that is or can be actuated as needed.

2. The ventilation apparatus (20) according to claim 1 wherein the ventilation apparatus (20) comprises a cover (24) that at least partially or regionally forms a housing and is or can be connected to the frame-like component (22) of the pressure limitation valve assembly (21) via a positive-locking connection in a releasable or exchangeable manner, andwherein, in a state of the cover (24) when it is connected to the frame-like component (22) of the pressure limitation valve assembly (21), it at least partially or regionally receives and positions and/or fixes the ventilator device (23).

3. The ventilation apparatus (20) according to claim 2, wherein, in a state of the cover (24) when it is connected to the frame-like component (22) of the pressure limitation valve assembly (21), the ventilator device (23) is received at least partially or regionally in a region delimited by the cover (24) and the frame-like component (22).

4. The ventilation apparatus (20) according to claim 2, wherein the cover (24) is configured so as to at least partially or regionally receive the ventilator device (23), in a releasable or exchangeable manner, and wherein the cover (24) comprises in particular a receptacle region, which is configured so as to be at least partially or regionally complementary to an outer contour of the ventilator device (23) and in which the ventilator device (23) can be received.

5. The ventilation apparatus (20) according to claim 2, wherein the cover (24) comprises a first end-side inlet region (26) and an opposing second end-side outlet region (27), and wherein the pressure limitation valve assembly (21) is or can be arranged at or in the outlet region (27) of the cover (24).

6. The ventilation apparatus (20) according to claim 5, wherein the ventilator device (23) is or can be arranged at or in the inlet region (26) of the cover (24).

7. The ventilation apparatus (20) according to claim 2, wherein the pressure limitation valve assembly (21) comprises at least one check valve, which is configured so as to permit a gas flow, and in particular an air flow, only from the inlet region (26) to or through the outlet region (27) of the cover (24).

8. The ventilation apparatus (20) according to claim 7, wherein the at least one check valve comprises at least one closing element (11), in particular in the form of a check flap, andwherein the at least one closing element (11) can be moved, and in particular pivoted, between an open position and a closed position.

9. The ventilation apparatus (20) according to claim 8, wherein the at least one check valve is configured such that the at least one closing element (11) is pressed into a sealing seat associated with the at least one closing element (11) by way of gravity and/or by way of the flow pressure of the gas flow and in particular air flow; or wherein the at least one check valve is configured as a spring-loaded check valve.

10. The ventilation apparatus (20) according to claim 2, wherein the ventilator device (23) is configured so as to initiate a gas flow, and in particular an air flow, from the inlet region (26) to or through the outlet region (27) of the cover (24), as needed.

11. The ventilation apparatus (20) according to claim 1, wherein the ventilator device (23) comprises at least one axial ventilator.

12. The ventilation apparatus (20) according to claim 1, wherein the ventilator device (23) is associated with an energy source, being in particular independent from the power supply of the vehicle, for the as-needed power supply of the ventilator device (23).

13. The ventilation apparatus (20) according to claim 1, wherein the ventilation apparatus (20) comprises at least one sensory system, or wherein the ventilation apparatus (20) is associated with at least one sensory system.

14. A ventilation apparatus (20) according to claim 13, wherein the at least one sensory system comprises at least one air quality sensor, which is configured so as to monitor the air, in particular in the vehicle cabin and/or in the housing (7) formed at least partially or regionally by the cover (24), in particular continuously or at predetermined or at predefined or definable times and/or events, with the task of detecting and measuring pollutants.

15. A ventilation apparatus (20) according to claim 13, wherein the ventilation apparatus (20) comprises a control device.

16. A ventilation apparatus (20) according to claim 13, wherein the ventilation apparatus (20) is associated with a control device, which is configured so as to evaluate a type and/or concentration of any pollutants measured by the at least one air quality sensor and to actuate the ventilator device (23) upon reaching and/or exceeding a critical pollutant type and/or pollutant concentration.
